(19) United States
(12) Patent Application Publication
(10) Pub. No.: US 2004/0137251 A1
(43) Pub. Date: Jul. 15, 2004

(54) Poly(phenylene ether)-polyvinyl thermosetting adhesives films, and substrates made therefrom

(76) Inventors: Michael John Davis, Coshocton, OH (US); James Estel Tracy, Killbuck, OH (US); Hua Guo, Selkirk, NY (US)

Correspondence Address: Jerry K. Mueller, Jr., Mueller and Smith, LPA, 7700 Rivers Edge Drive, Columbus, OH, 43235, US

(21) Appl. No.: 10/623,050

(22) Filed: Jul. 18, 2003

Related U.S. Application Data
(60) Provisional application No. 60/440,027, filed on Jan. 14, 2003.

(51) Int. Cl. B32B 15/04

(52) U.S. Cl. 428/500; 428/461

(57) ABSTRACT

This invention is directed to an adhesive resin composition having better processability, exhibiting reduced B-staged (partially cured) friability, and capable of being produced in a wide range of flow characteristics dependent upon the applications desired. Specifically, the composition, comprising a poly(arylene ether)-polyvinyl resin and curable unsaturated monomer, is applied to a metal foil or thermoplastic substrate or a free-standing film. The thermoplastic substrate may have an electrically conductive metal, such as copper, on one side. Better final film properties can be achieved by tailored functionality of cross-linking by control of ingredients and/or chain length (molecular weight) of ingredients used in making the novel adhesive composition.

### CROSS-REFERENCE TO RELATED APPLICATIONS

None

### STATEMENT REGARDING FEDERALLY SPONSORED RESEARCH

Not applicable.

### BACKGROUND OF THE INVENTION

The present invention relates to molding and adhesive compositions and films for thermosetting substrates and methods of manufacture thereof. More particularly, the present invention relates to such compositions comprising poly(arylene ether)-polyvinyl polymers.

There remains a continuing need in the art for thermosetting materials for use with metal and thermoplastic adherends, particularly substrates that are used in, or associated with, fabricating electrical components and printed circuit boards. As an example, the need for miniaturization of circuit boards has increased and methods such as incorporation of microvias in printed circuit boards have been developed. Furthermore, it would be beneficial to have variety of substrate choices capable of microvia technology and capable of being laser drilled without interference of reinforcements, such as woven or chopped fiberglass.

In the fabrication of printed circuit boards, it is known to use copper foil coated with adhesive, or copper foil with a cured adhesive, which is then coated with adhesive and partially cured as described in U.S. Pat. No. 5,557,843. This method is limited by the thickness of the copper foil that can be effectively coated and handled for practical use in the printed circuit board or rigid-flex board. Poly(phenylene ether)-Polyvinyl (PPE-PV) thermosetting adhesives overcome the brittle nature of common epoxy resin adhesives and offer superior electrical properties and handling characteristics. Thermoplastic films are known which are metallized with copper or other conductive material to thicknesses, such as 3 microns or 5 microns. Examples of metallized polyimides are described in, for example, U.S. Pat. Nos. 4,842,946 and 4,959,121. These metallized films can be coated with adhesive and used, for example, in microvia and rigid-flex applications.

The uses of these adhesive and film compositions are useful to, but not limited to, direct printed circuit board application. The molding, adhesive, and film compositions are anticipated in applications outside of the printed circuit board, such applications requiring excellent insulating characteristics and physical properties, such as moisture resistance and electrical properties. Such areas include, inter alia, microwave, antenna dish, radar domes, electrical I-beams and capacitors, to name but a few. Other uses for the curable film compositions are conceivable, such as, for example, solder masks and conformal coatings.

### BRIEF SUMMARY OF THE INVENTION

This invention is directed to resin compositions having better processability, exhibiting reduced B-staged (partially cured) friability, and capable of being produced in a wide range of characteristics dependent upon the applications desired. Specifically, the composition, a poly(arylene ether)-polyvinyl resin and curable unsaturated monomer and alternatively, a neat poly(arylene ether)-polyvinyl resin for film application, which may include a curable unsaturated monomer, is applied to a metal foil or thermoplastic substrate or used as a (free-standing) film. The thermoplastic substrate may have an electrically conductive metal, such as copper, on one or both sides. Selective properties can be achieved by tailored functionality of cross-linking by control of ingredients and/or chain length (molecular weight) of ingredients used to produce the desired thermoset articles. The inventive resinous composition, then, is expected to have dielectric properties, water adsorption properties, and processability equal to, if not better than, conventional resins.

### DETAILED DESCRIPTION OF THE INVENTION

The reactively endcapped PPE compounds include compounds derived by reacting any of the known PPE compounds containing phenolic hydroxyl residues at a concentration of greater than about 5 ppm with a reactive capping agent. Such uncapped PPE compounds are described in a variety of patents and publications such as, for example, in U.S. Pat. Nos. 6,352,782, 5,352,745, 5213,886, and 5,834,565, the disclosures of which are expressly incorporated herein by reference.

In one embodiment, the reactively capped PPE compounds include those containing recurring units of structure 3. In another embodiment, poly(phenylene ether) compounds are of general structure 1

Q-(J-K)_{y} 1

wherein Q is the residuum of a phenol, including polyfunctional phenols, and includes radicals of the following structure, 2:

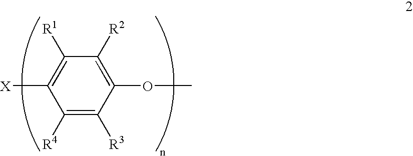

wherein, for structure 2, X is hydrogen, substituted or unsubstituted C₁₋₁₀₀ alkyl, aryl, and mixed alkyl-aryl hydrocarbons, or such hydrocarbon groups containing a substituent selected from the group consisting of carboxylic acid, aldehyde, alcohol, and amino radicals. X also may be sulfur, sulfonyl, sulfuryl, oxygen, or other such bridging group having a valency of 2 to result in various bis- or higher polyphenols. R¹⁻⁴ independently may be hydrogen, substituted or unsubstituted C₁₋₁₀₀ alkyl, alkenyl, alkynoyl, aryl, mixed alkyl-aryl hydrocarbons, or such groups also containing a substituent selected from the group consisting of carboxylic acid, aldehyde, alcohol, and amino functionality (e.g., amide or imide group); y and n independently range from about 1-100, in another embodiment about 1-3, and in a further embodiment about 1-2; and in yet another embodiment, y and n are the same; and J comprises recurring units of the following structure, 3:

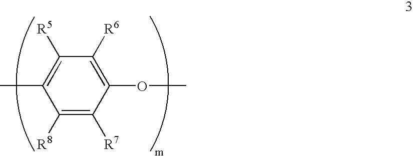

wherein, for structure 3, R⁵⁻⁸ independently may be hydrogen, alkyl, alkenyl, alkynoyl, aryl, mixed alkyl-aryl hydrocarbons, or such groups also containing a substituent selected from the group consisting of carboxylic acid, aldehyde, alcohol, and amino functionality (e.g., amide or imide group), and m ranges from 1-200, and K has the following structure:

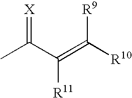

wherein X is O, S, or two hydrogens, preferably S or O, and wherein R⁹⁻¹¹ are independently a hydrogen or substituted or unsubstituted C₁₋₁₀₀ alkyl or aryl or mixed alkyl or aryl group. Preferably, R⁹⁻¹⁰ are hydrogen and R¹¹ is a methyl. Any of the foregoing “R” substituents optionally may be partially or fully halogenated (e.g., F). Additionally, any one of the R⁵⁻⁸ substituents also may be used for the R¹⁻⁴ groups.

For adhesive coating applications, the reactively capped PPEs are low molecular weight PPEs with an average molecular weight of less than about 3000 in one embodiment; between about 500 to about 2,900 in another embodiment; and, in a further embodiment, about 800 to about 2,200 g/mol. In one embodiment of the present invention, the PPE may contain low levels of amine containing end groups derived from well-known catalyst side reactions. Such amine containing end groups can be removed prior to reactively capping the PPE. Such materials may be prepared by processing the uncapped PPE at temperatures ranging from about 150° C. to about 350° C. followed by capping. Prior to capping, the low molecular weight polyphenylene ethers employed herein may be prepared from PPE typically having an average molecular weight in the range of about 7,000-50,000.

Such preparation of a low molecular PPE composition can be accomplished by a redistribution reaction, such as, for example, by reacting the PPE with an oxidizing agent such as, for example, a peroxide or a quinone with or without a phenol (including bisphenols). Another redistribution procedure is to obtain a low molecular weight PPE by oxidative coupling as described above to produce resins of less than 3,000 number average molecular weight which are isolated, preferably, by a direct isolation method. Direct isolation is a process in which the PPE resin is isolated from the solvent used in polymerization by heating under reduced pressure. However, even such low molecular weight resins can optionally be functionalized with a peroxide, or a peroxide and a phenol, to achieve even lower molecular weight resins.

In one embodiment, reactively capped PPEs for film forming applications are higher molecular weight PPEs with an average molecular weight ranging from between about 12,000 to about 80,000 g/mol.

A capping catalyst often is employed in the generation of the reactively capped PPE. Examples of such compounds include those known to the art that are capable of catalyzing condensation of phenols with the capping agents described below. Useful materials are basic compounds including, for example, basic compound hydroxide salts such as sodium, potassium, or tetraalkylammonium hydroxides; or tertiary alkyl amines such as tributyl amine, triethylamine, dimethylbenzylamine, dimethylbutylamine and the like; tertiary mixed alkyl-arylamines and substituted derivatives thereof such as dimethylaniline; heterocyclic amines such as imidazoles or pyridines and substituted derivatives thereof such as 2-methylimidazole, 2-vinylimidazole, 4-(dimethylamino)pyridine, 2-, 3-, or 4-vinylpyridine. Also useful are organometallic salts such as, for example, tin and zinc salts known to catalyze the condensation of, for example, isocyanates or cyanate esters with phenols. The organometallic salts useful in this regard are known to the art in numerous publications and patents well known to those skilled in this art.

Capping agents include compounds known in the literature to react with phenolic groups, and which contain carbon-carbon unsaturation for curing into the thermoset matrix via polymerization of its unsaturation following the capping reaction. Such compounds include both monomers and polymers containing, for example, anhydride, acid chloride, epoxy, carbonate, ester, isocyanate, cyanate ester, or alkyl halide radicals. Capping agents are not limited to organic compounds as, for example, phosphorus and sulfur based capping agents also are included. Examples of such compounds include, for example, acrylic anhydride, methacrylic anhydride, glycidylacrylate or glycidylmethacrylate, acetyl chloride, benzoyl chloride, diphenyl such as di(4-nitrophenyl)carbonate, acryloyl, methacryloyl or acetyl esters, phenylisocyanate, 3-isopropenyl-a,a-dimethylphenylisocyanate, cyanatobenzene, 2,2-bis(4-cyanatophenyl)propane), 3- or 4-(a-chloromethyl)styrene, allyl bromide, and the like, carbonate and substituted derivatives thereof and mixtures thereof.

In one embodiment, capped poly(phenylene ether)s of the present invention include those of the general structure, 1:

Q-(J-K)ₘ 1

wherein Q is the residuum of a phenol;

J comprises recurring units of the following structure, 3:

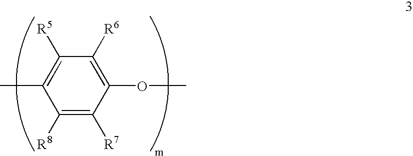

wherein, for structure 3, R⁵⁻⁸ independently is selected from hydrogen, alkyl, alkenyl, alkynoyl, aryl, mixed alkyl-aryl hydrocarbons, wherein such groups may contain a substituent selected from carboxylic acid, aldehyde, alcohol, and amino functionality; K has the following structure:

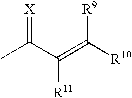

wherein R⁹⁻¹¹ is a hydrogen or substituted or unsubstituted C₁₋₁₀₀ alkyl or aryl or mixed alkyl or aryl group; X is an oxygen, and m ranges from 1-200.

Preferable capped poly(phenylene ether)s of the present invention include methacrylate capped polyphenylene ethers produced by reacting a poly(phenylene ether) with, for example, methacrylic anhydride in the presence of a capping catalyst. In one embodiment at least 10%, in another embodiment at least 50%, and in a further embodiment substantially all of the hydroxyl end groups be capped.

An alternative process to prepare the capped PPE, as disclosed in U.S. Pat. Nos. 6,384,176 and 6,469,124, comprises oxidative coupling in a reaction solution at least one monovalent phenol species using an oxygen containing gas and a complex metal catalyst to produce a PPE; and functionalizing the PPE, preferably prior to and/or during at least one isolation step for devolatilization of the reaction solvent, with an unsaturated compound of the formula (I):

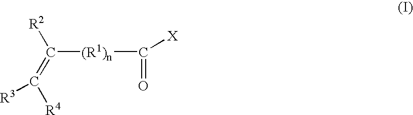

wherein R¹ is an aliphatic or aromatic residue, for example, —CH₂—but may be multiple —CH₂—groups, e.g., n can vary from 1 to about 10 or more, or alternatively, n may equal zero wherein the formula is an acrylic residue, and wherein each of R², R³, and R⁴ are independently hydrogen, alkyl, or aryl, and wherein X is a residue of one of the following formulae (II):

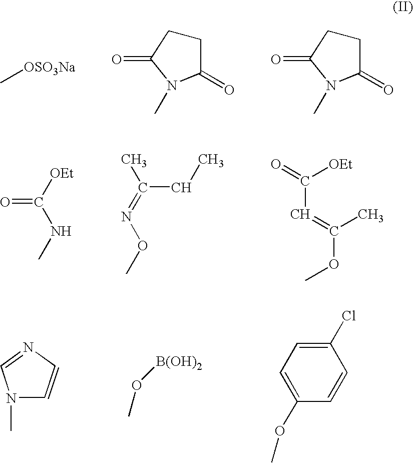

or wherein X is a halogen or a residue of the formula (III):

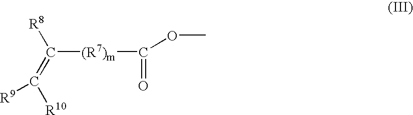

wherein R⁷ is an aliphatic or aromatic residue, for example, —CH₂—but may be multiple —CH₂—groups, e.g., m can vary from 1 to about 10 or more, or alternatively, m may equal zero (wherein if n and m both equal zero, the unsaturated compound is an acrylic anhydride), and wherein each R⁸, R⁹, and R¹⁰ are independently hydrogen, alkyl, or aryl. In a preferred embodiment, the unsaturated compound is of the formula (IV):

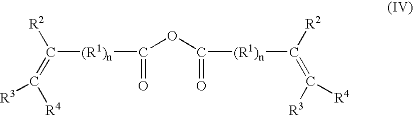

wherein each of n, R¹, R², R³, and R⁴ are as previously described. In an especially preferred embodiment, the unsaturated compound is of the formula (V):

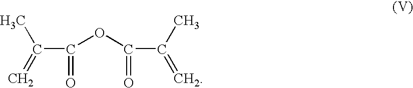

Compounds containing one carbon-carbon double or triple bond include known vinyl monomers such as styrene or substituted derivatives thereof derivatives thereof such as, 2-,3- or 4-methylstyrene, a-methyl styrene, also useful are acrylic acid or acrylic esters and maleic anhydride. Such vinyl monomers may also contain bromine to enhance the flame properties of these resins. Such compounds include brominated styrenes such as 2,4,6-tribromostyrene, or pentabromobenzylacrylate.

Compounds containing greater than one carbon-carbon double or triple bond include unsaturated polyesters, such as the condensation products of alkylene or mixed alkyl-arylene diols including propylene glycol, ethylene glycol, bisphenol-A, tetrabromobisphenol-A, and member or members selected from the group consisting of diacids and anhydrides. Typical of this type of compound is the condensation product of propylene glycol, maleic anhydride and isophthalic acid. Also included are condensation products of bisphenols, including brominated bisphenols, such as those described by formulas 4 and 5.

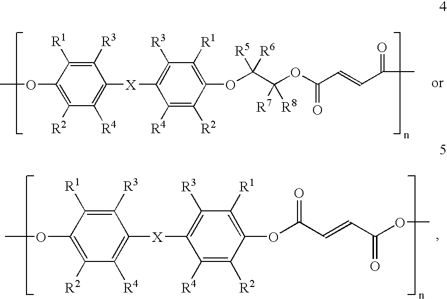

wherein, for structures 4 and 5, R¹-R⁴ are independently hydrogen, alkyl, halo, aryl; R⁵—R⁸ may be independently alkyl, aryl or mixed alkylaryl hydrocarbons, X is a carbon-carbon single bond, alkyl, aryl or mixed alkylaryl hydrocarbons, thio, sulfonyl, sulfuryl, phospate or substituted phosphine or phosphine oxide. Other polymers contain thermoplasics modified with carbon-carbon double or triple bonds such as phenylethynyl capped polyimide, polysulfone or hydroxystyrene containing polymers. Also useful are compounds containing a triazine moiety and a polymerizable carbon-carbon double bond. Such materials include triallylcyanurate, triallylisocyanurate, and the triazine compounds shown in structures 6-11 may be useful because of the excellent dielectric properties of the triazine moiety.

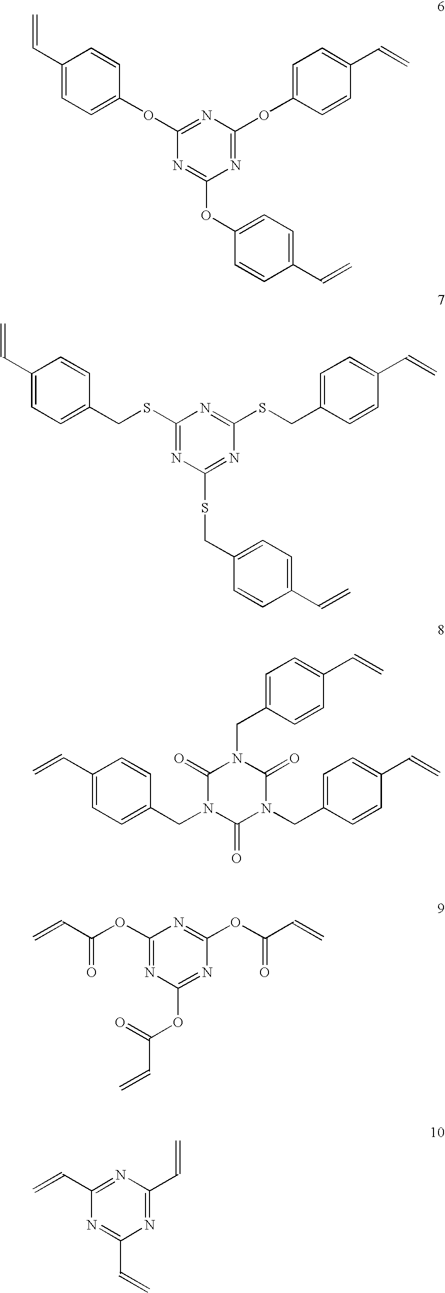

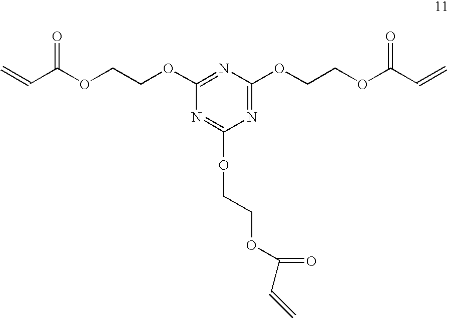

Also useful are allylic compounds such as diallyl phthalate, diallylisophthalate, and prepolymers therefrom and acrylates such as the diacrylate produced by condensation of acrylic acid with a diglycidyl ether, such as bisphenol-A diglycidyl ether.

Other compounds containing carbon-carbon double or triple bonds include, inter alia, condensation products of acryloyl chloride with multifunctional alcohols. Typical of this type would be 2,2-bis((4-(2-acryloxyethoxy)phenyl)propane) or 1,2,3-propanetriol triacrylate.

In addition to the aforementioned components, polymerization catalysts for the unsaturated components may be included. The polymerization catalyst would include any compound capable of producing radicals at elevated temperatures. This would include both peroxy and non-peroxy based radical initiators known in the art to polymerize the aforementioned carbon-carbon double and triple bond containing compounds. Examples of peroxy initiators useful in the present invention include 2,5-dimethylhexane-2,5-dihydroperoxide, 2,5-dimethyl-2,5-di(t-butylperoxy)-hex-3-yne, di-t-butylperoxide, t-butylcumyl peroxide, a,a′-bis(t-butylperoxy-m-isopropyl)benzene, 2,5-dimethyl-2,5-di(t-butylperoxy)hexane, dicumylperoxide, di(t-butylperoxy isophthalate, t-butylperoxybenzoate, 2,2-bis(t-butylperoxy)butane, 2,2-bis(t-butylperoxy)octane, 2,5-dimethyl-2,5-di(benzoylperoxy)hexane, di(trimethylsilyl)peroxide, and trimethylsilylphenyltriphenylsilyl peroxide and the like. Typical non-peroxy initiators would include compounds such as 2,3-dimethyl-2,3-diphenylbutane, 2,3-trimethylsilyloxy-2,3-diphenylbutane and the like.

Also included in the composition of the invention are curable compositions wherein an extending filler or an additive, or mixtures thereof, may be incorporated in order to impart or enhance desired properties to the composition and applications. Such desired properties include dielectric constant, dissipation factor, thermal conductivity, flow, peel or adhesive strength, expansion and shrinkage, as well as cure type. Representative examples of extending fillers are one or more of carbon black, silica, alumina, magnesia, talc, mica, glass beads, or hollow glass spheres, etc. Representative examples of additives, inter alia, are one or more of antioxidants, thermal and ultraviolet stabilizers, lubricants, anti-static agents, plasticizers, pigments, dyes, colorants, ceramic additives to enhance electrical properties, and flame-retardants and agents used to enhance the flame retardancy of the resin, all in conventional proportions. Materials in the additive class include, for example, Sb₂O₅, NaSbO₃⁻¼H₂O and the like. Furthermore an additional complementary, non-reactive material comprising a thermoset, thermoplastic or elastomeric resin (e.g., one or more of nylon, polystyrene, or polypropylene) can be included in the compositions, either alone or in combination, for the purpose of improving properties such as toughness, impact strength or thermal stability.

As stated above, the inventive adhesive resin composition can be applied to a substrate, including, for example, polymeric substrates that may have a metal film on at least one side. Representative metallic foils useful in the invention, for example, are copper foil, aluminum foil, or the like. Generally, the thickness of the metallic foil is from about 3 micrometers (μm) to about 200 μm, and preferably from about 5 μm to 100 μm. Additionally, the inventive adhesive resin composition can be applied onto a polymeric film, which may include, for example, polyimides, poly(phenylene ether)s, and other thermoplastics, and the like. In both applications, the adhesive resin composition can be in B-staged state.

An aspect of the immediate invention is a thermosetting film, passing through an intermediate B-stage step to a cured C-stage. For these applications, it is desirable to have higher molecular weight PPE-PV, with or without an additional reactive moiety, for promoting film formation. The resulting film is not soluble in the solvent mixture from which it was cast. The inventive film composition may be metalized via vapor deposition processes or the like. The film may be impregnated with zirconium, zirconium nitride, titanium, titanium nitride, zirconium carbonitride, chromium, chromium nitride, copper, nickel, nickel nitride, titanium carbonitride, gold, silver, carbon nitride, aluminum, molybdenum, for example, depending on the end application desired.

Generally, the thickness of the impregnated metal (i.e., penetrated film) ranges from about 0.01 microns to 1.5 microns and such thickness can be from about 0.2 to 1.0 microns with between about 0.5-5.0 microns applied topically and in another embodiment from between about 0.7 to 3.0 microns applied topically. For instance, the use of aluminum would have desirable benefits for capacitor applications, while the use of copper would have desirable benefits for flexible circuits in a printed wire board or other application requiring a flexible-type circuit such as horn switches and automotive dashboard.

In this regard, the following references teach metallizing of films, such as can be practiced with the inventive adhesive resin composition disclosed herein: U.S. Pat. Nos. 5,413,817; 5,316,867; 4,588,623; and 4,975,327, and references cited therein, the disclosures of which are expressly incorporated herein by reference.

In use, the adhesive compositions are blended and then applied to the adherends by known methods, including spreading or dipping, as well as by various known roll transfer manufacturing methods. Such methods include multiple roll, reverse roll, direct gravure, reverse gravure, wire rod, air knife, knife over roll, hot melt die, and EDI slot die. Low to medium shear rate applications, then, can be used in applying the inventive adhesive resin composition. Solvent, if present, is removed, generally in heat convection ovens with single or multiple zones, and the adhesive composition is partially cured to the b-stage form or completely cured, depending upon the application. The inventive adhesive resin composition, then, can be used as an adhesive or as a cap layer or as a component of multiple-step sequential laminations for microvia applications in printed circuit board applications, for instance.

The composition may be cured to the desired degree by any of a number of techniques known to one skilled in the art, including, for example, heating or exposure to light or an electron beam. When heating is used, the temperature selected can be from about 800 to about 300° C. in one embodiment, and from about 90° to about 240° C. in another embodiment. The heating period can be from about 1 minute to about 10 hours in one embodiment, from about 1 minute to about 6 hours in another embodiment, and from about 40 minutes to about 5 hours in yet another embodiment.

Moreover, the inventive film forming composition can be applied onto a releasable surface, stripped of solvent and cured to provide a free-standing film. Solvent casting manufacturing methods are processes by which a polymer or polymer mixture in a carrier solvent is spread onto a moving surface. The solvent portion is evaporated, leaving behind film, which is separated from the moving surface. The moving surface could be, for example, a metal belt or rotary drum.

A suitable solvent system for the PPE-PV, and additional monomers or other additives that may be desirable to use, is helpful for proper film formation. The solution requirement is to develop reasonable viscosity at about 75% or less solids percent in one embodiment, and 8-25% solids in another embodiment. The solvent system may contain a low vapor pressure solvent for fast evaporation, non-flammable solvents, and non-corrosive solvents. The solvent also may contain additives to aid in the release of the film from the moving surface, including, for example, higher boiling non-solvents (anti-solvents) and possibly even solid phase release agents (such as Zonyl® supplied by DuPont) or other thermoplastics including but not limited to polypropylene. In one embodiment this polymer solution is filtered prior to solvent casting to remove fine particulates.

One such suitable solvent system includes, but is not limited to, chloroform, methylene chloride, and toluene, which solvent system may be used to dissolve the PPE-PV, other reactive monomers, catalyst, and additives. The solvent range for solubility is 0-100% chloroform, 0-100% methylene chloride, and 0-100% toluene. In one embodiment, the solvent mixture consists of 35-75% chloroform, 1-20% methylene chloride, and 0-15% toluene.

Film thickness control may be achieved through several methods obvious to those familiar in the art. Applicators of the polymer solution include, inter alia, knife-edge, round bar or v-shaped trough to control flow to the surface of the moving surface. Precision made doctor bars are routinely used to control wet film thickness. The gap between the doctor bar and the moving surface typically controls the wet film thickness with a ratio of 3:0.5 (gap:wet film thickness) in one embodiment and 2:1 in another embodiment. The tolerance of the doctor bar to the moving surface in one embodiment is within ±25%, in another embodiment within ±10%, and in a further embodiment than +10%.

The solids concentration of the starting solution of PPE-PV, reactive monomers, if any, and additives, if desired, is such that the ratio of wet film thickness to dry film thickness, prior to any post finishing operations, is 10:5 in one embodiment, 10:3 in another embodiment, and in the range of about 10:1 in a further embodiment.

The air temperature and velocities around the moving surface may be controlled concurrent or counter-current in flow using single, multiple sources of inlets, and/or outlets, to control solvent evaporation rates and effect final film quality and production rates. The temperature of the air can be high enough to warm the solvent-laden wet film and promote evaporation without boiling solvent. The airflow can be used to prevent condensation of evaporated solvent onto the drying film, which can be accomplished by adequate insulation of the drying chamber, for example. Solvent-rich airflows typically are directed to recovery units, while solvent lean air may be re-warmed in heat exchange units and re-used to continue drying the wet film.

After the film has been separated from the moving surface, the self-supporting film is taken through heated rollers or “after dryers”, which are typically used to reduce the solvent level to the desired level for the intended application. The after dryers are useful in initiating and completing cross-linking reactions of the PPE-PV and other appropriate reactive moieties, if any.

Post film finishing operations, such as stretching, if desired, may be used to reduce thickness of the self-supporting film further. Potential benefits from such post-processing operations may include orientation of molecular structure of the polymer system, coefficient of thermal expansion improvements, tensile strength improvements, resistance to tears, and the like. The film can be stretched to a thickness ratio of 1:1 (dry film:stretched film) in one embodiment, to a thickness ration of 2:1 in another embodiment, and to a thickness ration of 3:1 in further embodiment.

The instant invention includes stable, catalyzed, curable, film formulations that may be cured by heat, ion beam or UV light techniques know to those familiar in the art. The curable film compositions are not soluble in the solvent system from which it they are cast after cure has occurred. It is possible to maintain the film in a partially cured, or b-staged form, for indefinite periods of time,

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated. Also, all citations referred herein are expressly incorporated herein by reference.

### EXAMPLES

Experimental Procedure—Poly(arylene ether)-polyvinyl (PPE-PV)

Mixes were prepared by dissolving PPE-PV (poly(phenylenether)-polyvinyl resin) in toluene (adding monomers and/or flame retardants if included) with heating and stirring until a uniform solution, or in the case of insoluble additives such as ATH, until a uniform slurry, was obtained. After cooling to room temperature, the required amount of peroxide was added. Aldrich 2,5-Bis(tert-butylperoxy)-2,5-dimethyl-3-hexyne, tech., 90% [Lupersol 130] was the peroxide used in all formulations.

Coated metals of the catalyzed mixes then were prepared on sheets of copper foil (0.5 oz/sq. ft.) using a wire-wrapped applicator bar (Bird #42).

For peel strength evaluations, the curable compositions were applied to the matte side of the copper foil, and, after allowing the coating to dry at ambient temperature, the coated copper was laminated to unclad high temperature electrical laminate (thickness approx. 1.4 mm) at 200 psi and 190° C. for 4 hrs in a steam-heated hydraulic press. Peel strengths were measured on two etched 3.18 mm traces from the center of the test board, in accordance with standard procedures.

For expansion values, Tg and electrical properties, coated samples were prepared on the drum side of copper sheets, and after drying at ambient temperature, the dried material was removed. The curable composition then was molded into a circular test specimen of approximately 1.65 mm in thickness. A quantity to be molded (about 5 g) was weighed into a circular cavity for curing using heat and pressure. The mold was placed in an electrically heated press at 200 psi and 190° C. for four hours. At the end of the molding period, the platens were turned off and the molded specimen allowed to cool slowly under pressure to about 90° C. before removing it from the press and isolating the test specimen.

Expansion values (% z-axis expansion, exp.) and Tg values (° C.) were measured by thermal mechanical analysis (TMA). Dielectric constants (Dk) and dissipation factors (Df) were measured at 1 GHz on a HP 4291B dielectric analyzer (Hewlett Packard).

Copper clad, flexible films of selected formulations were obtained by laminating two of the coated foils together at 200 psi and 190° C. for 4 hrs.

### DESCRIPTION OF MATERIALS

PPE-PV—Inventive poly(phenylene ether)-polyvinyl resin

DITRIMETHYLOLPROPANE TETRAACRYLATE (DMPTA)—Sartomer SR355

1,6-HEXANEDIOL DIACRYLATE (1,6-HD)—Sartomer SR238

EPOXY ACRYLATE (EA)—Sartomer CN104

TRIMETHYLOLPROPANE TRIACRYLATE (TMPTA)—Sartomer SR351

ETHOXYLATED TRIMETHYLOLPROPANE TRIACRYLATE (ETMPTA)—Sartomer SR454

ETHOXYLATED BPA DIACRYLATE (EBPAA)—Sartomer SR349

ETHOXYLATED BPA DIMETHACRYLATE—Sartomer SR348

TAC—Triallyl cyanurate (Degussa)

ETHOXYLATED TBBPA DIACRYLATE (ETBBPADA)-Aldrich [2,2′,6,6′-Tetrabromobisphenol A ethoxylate (1 EO/phenol)diacrylate]

DIBROMOSTYRENE (DBS)—Great Lakes DBS

ATH—Aluminum trihydrate (Alcoa)

DER—Dow DER 542 brominated epoxy resin

TBBPA—Tetrabromobisphenol A (Great Lakes BA-59)

ETHACURE—Albemarle Ethacure 100 amine curing agent

TAIC—Triallyl Isocyanurate (Degussa)

Hycar—Noveon HCAR 2000×168

RDX PPE-PV—redistributed PPE (0.401V to 0.151V), isolated, and capped —prepared by Global Noryl Technology

0.301V PPE-PV—prepared by General Electric Corporate Research

0.401V PPE-PV—prepared by General Electric Corporate Research

OP930—Clariant Exolit OP930

TTT—Ameribrom FR-245 [2,4,6-Tris(2,4,6-tribromophenoxy)-1,3,5-triazine]

TABLE 1

| | | Monomer | | Per- | Tolune | FR | | | | | | | |
|---|---|---|---|---|---|---|---|---|---|---|---|---|---|
| | PPE- | | Amt | oxide | Amt. | | Amt. | Peel | %-Z | Thk | | | |
| ID | PV | Type | (g) | Amt. (g) | (g) | Type | (g) | (lb/in²) | Exp | (mm) | Tg | Dk | Df |
| 228-4/5-1 | 24 | — | — | 0.75 | 44 | — | — | 1.2/1.2 | — | — | — | — | — |
| 253-6/6-1 | 24 | — | — | 0.8 | 20 | — | — | — | 6.47 | 1.409 | 149.1 | — | — |
| 253/6/6-4 | 24 | — | — | 0.2 | 20 | — | — | 2.8/2.7 | Melted at about 200° C. | | | | |
| 260-6/24-1 | 24 | — | — | 1.5 | 25 | — | — | 5.9/6.2 | — | — | — | — | — |
| 260-6/24-5 | 24 | — | — | 2.5 | 25 | — | — | 3.0/3.1 | — | — | — | — | — |
| 252-5/31-1 | 24 | DMPTA | 9 | 1.5 | 20 | — | — | 4.8/5.1 | 2.52 | 1.679 | 185.4 | — | — |
| 251-5/24 | 24 | 1,6-HD | 8 | 1.5 | 10 | — | — | 2.1/2.2 | — | — | — | — | — |
| 254-6/10-1 | 24 | EA | 10 | 1.5 | 30 | — | — | 7.6/7.8 | 4.81 | 1.827 | 133.1 | — | — |
| 258-6/10-1 | 24 | TMPTA | 10 | 1.5 | 25 | — | — | 6.5/6.7 | 2.64 | 1.596 | 173.7 | — | — |
| 254-6/10-2 | 24 | ETMPTA | 10 | 1.5 | 25 | — | — | 4.5/4.7 | 3.35 | 1.76 | 159.7 | — | — |
| 254-6/10-3 | 24 | EBPAA | 10 | 1.5 | 22 | — | — | 6.2/6.2 | 4.22 | 1.769 | 137.6 | — | — |
| 252-5/31-2 | 24 | EBPAA | 4 | 1.5 | 20 | — | — | 4.5/4.5 | 5.52 | 1.783 | 129.6 | Flexible | |
| | | | | | | | | | | | | film | |
| 257-6/18-3 | 24 | TAC | 10 | 1.5 | 15 | — | — | 7.1/7.4 | 2.44 | 1.545 | 186.5 | 2.727 | 0.0052 |
| 228-4/5-2 | 24 | ETBBPADA | 18 | 1.5 | 20 | — | — | 5.7/5.8 | | — | — | — | — |
| 233-4/12 | 24 | ETBBPADA | 10 | 1.5 | 10 | — | — | 5.5/5.5 | — | — | — | — | — |
| 233-4/12 | 24 | ETBBPADA | 10 | 1.5 | 20 | — | — | 3.4/3.5 | Thinner | | — | — | — |
| | | | | | | | | | film | | | | |
| 237-4/18 | 24 | DBS | 8 | 1.5 | 8 | — | — | 5.0/4.2 | — | — | — | — | — |
| 237-4/18 | 24 | DBS | 4 | 1 | 15 | — | — | 3.0/2.7 | — | — | — | — | — |
| 260-6/24-3 | 24 | — | — | 1.5 | 25 | ATH | 14 | 5.1/5.2 | 8.05 | 1.772 | 168.7 | 3.13 | 0.007 |
| 256-6/13-2 | 24 | — | — | 1.5 | 28 | DER | 12 | 5.9/5.9 | — | — | — | — | — |
| 259-6/20-2 | 24 | — | — | 1.5 | 35 | DER | 15 | 3.7/3.7 | — | — | — | — | — |
| 256-6/13-3 | 24 | — | — | 1.6 | 28 | DER | 12 | 5.2/5.4 | — | — | — | — | — |
| | | | | | | TBBPA | 1.5 | | | | | | |
| | | | | | | Ethacure | 0.2 | | | | | | |
| 257-6/18-2 | 24 | TAC | 10 | 1.5 | 15 | TTT | 10 | 1.2/1.3 | 3.38 | 1.622 | 156.8 | — | — |
| 260-6/24-1 | 24 | DMPTA | 9 | 1.5 | 25 | ATH | 19 | 4.0/3.8 | 2.97 | 1.694 | 160.3 | 3.19 | 0.01 |
| 258-6/19-1 | 24 | DMPTA | 9 | 1.5 | 25 | TTT | 10 | 4.4/4.5 | 3.63 | 1.709 | 136.1 | 2.15 | 0.006 |
| 258-6/19-2 | 24 | DMPTA | 9 | 1.5 | 25 | TBBPA | 12 | 3.8/3.8 | — | — | — | — | — |
| 258-6/19-3 | 24 | DMPTA | 9 | 1.5 | 25 | DER | 15 | 5.5/5.4 | — | — | — | — | — |
| 259-6/20-1 | 24 | EBPAA | 2 | 1.5 | 35 | DER | 15 | 5.9/5.9 | — | — | — | — | — |
| 285-10/25-2 | 24 | TAC | 15 | 1.5 | 20 | TTT | 10 | 3.0/3.0 | 2.41 | 1.534 | 184.0 | — | — |
| 292-12/3-2 | 24 | TAC | 15 | 1.5 | 22 | TTT | 10 | 5.8/5.8 | 2.56 | 1.547 | 174.6 | — | — |
| | | HYCAR | 3 | | | | | | | | | | |
| 284-10/18-4 | 24 | TAC | 15 | 1.5 | 40 | OP930 | 10 | 3.5/3.5 | 2.65 | 1.657 | 173.2 | 2.654 | 0.003 |
| 291-11/25-1 | 24 | TAIC | 15 | 1.5 | 40 | OP930 | 10 | 4.7/4.7 | — | — | — | — | — |
| 285-10/25-2 | 24 | TAC | 15 | 1.5 | 30 | OP930 | 5 | 5.4/5.4 | 2.58 | 1.589 | 179.5 | — | — |
| 291-11/25-3 | 24 | TAIC | 15 | 1.5 | 30 | OP930 | 5 | 6.9/6.8 | — | — | — | — | — |
| 286-10/30-2 | 24 | Di-TMP | 10 | 1.5 | 40 | OP930 | 5 | 4.0/4.0 | 2.2 | 1.745 | 200.3 | 2.68 | 0.007 |
| | | 1,6-HD | 4 | | | | | | | | | | |
| 262-5/1-1 | 24 | TAC | 15 | 1.5 | 40 | OP930 | 5 | 3.7/4.2 | 2.93 | 1.636 | 168.5 | 2.65 | 0.002 |
| 292-12/3-4 | 24 | TAIC | 8 | 1.5 | 24 | DBS | 10 | 6.8/6.8 | 2.37 | 1.692 | 194.5 | — | — |
| 262-6/28-4 | 25 | EA | 10 | 1.5 | 25 | TTT | 11 | 3.5/3.5 | — | — | — | — | — |

Comparative Examples of Adhesive Compositions Utilizing Higher Molecular Weight PPE-PV

Examples of compositions for molding and adhesives were prepared in a similar fashion as described above. The purpose was to evaluate the effect on critical expansion properties.

TABLE 2

| | 0.12IV | 0.30IV | 0.40IV | Monomer | | Peroxide | Toluene | FR | | | %-Z | Thk | | | |
|---|---|---|---|---|---|---|---|---|---|---|---|---|---|---|---|
| ID | PPE-PV | PPE-PV | PPE-PV | Type | Amt | Amt. | Amt. | Type | Amt. | Peel | Exp | (mm) | Tg | Dk | Df |
| 262-5/1-2 | 18 | — | 6 | TAC | 15 | 1.5 | 40 | OP930 | 5 | 3.7/4.0 | 4.11 | 1.801 | 152.9 | 2.63 | 0.001 |
| 262-5/1-3 | 18 | 6 | — | TAC | 15 | 1.5 | 40 | OP930 | 5 | 2.3/2.5 | 5.66 | 1.771 | 138.4 | 2.65 | 0.001 |

Experimental Procedure—Vinyl-Capped PPE Film Casting Compositions

Solutions of 8-12% PPE-PV, with reactive monomers, if used, were prepared by heating and stirring in a chloroform, methylene chloride, toluene system. The resultant solution was cooled to room temperature and comparisons made with and without initiator added. The solution was applied to a release sheet using a wire-wrapped applicator bar. Solvent was removed at ambient temperature or optionally in a heated, convection, drying oven. The resultant self-supporting film then was separated from the release sheet. Glass transition temperature (Tg) was measured by differential scanning calorimetry; coefficient of thermal expansions measured by a thermomechanical analyzer; and Dk @ 1 GHz measured by an HP4292B dielectric analyzer (Hewlett Packard).

TABLE 3

| | | | | | Per- | Sol- | | | | Exp. | Exp. | | | |
|---|---|---|---|---|---|---|---|---|---|---|---|---|---|---|
| | | | | | ox- | vent | | | | Below | Above | | | CHCl3 |
| | PPE | | Monomer | | ide | Mix- | FR | | Tg | Tg | Tg | Dk | Df | Solu- |
| ID | Type | Amt | Type | Amt | Amt. | ture | Type | Amt | (° C. | (ppm) | (ppm) | 1 Ghz | 1 Ghz | bility |
| 332-143-1 | 0.3IV | 3 | — | — | 0.18 | 15 | — | — | 213.7 | — | — | 1.734 | <0.002 | No |
| | PPE-PV | | | | | | | | | | | | | |
| 332-144 | 0.4IV | 3 | — | — | 0.18 | 15 | — | — | 215.7 | — | — | 1.403 | <0.002 | No |
| | PPE-PV | | | | | | | | | | | | | |
| | 0.3IV | 68 | TAC | 15 | 2 | 623 | TTT | 15 | 169 | 110 | 398 | — | — | No |
| | PPE-PV | | | | | | | | | | | | | |
| | 0.3IV | 68 | — | — | 2 | 623 | TBBPA | 30 | 162 | 116 | 362 | — | — | No |
| | PPE-PV | | | | | | | | | | | | | |
| 262-5/19-1 | 0.3IV | 3 | — | — | — | 15 | — | — | 212.1 | — | — | 2.77 | <0.002 | Yes |
| | PPE-PV | | | | | | | | | | | | | |

| 262-5/20/1 | 0.12IV | 3 | — | — | 0.18 | 15 | — | — | Brittle, non-film former. | | | | | |
|---|---|---|---|---|---|---|---|---|---|---|---|---|---|---|
| | PPE-PV | | | | | | | | | | | | | |
| 262-5/20/2 | 0.15IV | 3 | — | — | 0.18 | 15 | — | — | Brittle, non-film former. | | | | | |
| | RDX | | | | | | | | | | | | | |
| | PPE-PV | | | | | | | | | | | | | |
| 262-5/20-3 | 0.40IV | 3 | — | — | — | 15 | — | — | 226 | — | — | — | — | Yes |
| | PPE | | | | | | | | | | | | | |

We claim:

1. A curable unreinforced resin composition comprising:
(a) at least one poly(arylene ether) polyvinyl resin having a molecular weight of between about 900 and 75,000; and
(b) at least one vinyl or acrylic-substituted resin.

2. The curable unreinforced resin composition of claim 1, wherein said poly(arylene ether) polyvinyl resin has an average molecular weight of less than about 10,000 g/mol.

3. The curable unreinforced resin composition of claim 2, wherein said poly(arylene ether) polyvinyl resin has a number average molecular weight of less than about 5,000 g/mol.

4. The curable unreinforced resin composition of claim 1, wherein said poly(arylene ether) polyvinyl resin has an average molecular weight of between about 20,000 and 75,000 g/mol.

5. The curable unreinforced resin composition of claim 4, wherein said poly(arylene ether) polyvinyl resin has an average molecular weight between abut 30,000 to about 71,000.

6. The curable unreinforced resin composition of claim 4, which additionally comprises a catalyst.

7. The curable unreinforced resin composition of claim 4, which additionally comprises a complementary, non-reactive material being one or more of a thermoset resin, a thermoplastic resin, or an elastomeric resin.

8. The curable unreinforced resin composition of claim 7, wherein said complementary, non-reactive material is one or more of nylon, polystyrene, or polypropylene.

9. The curable unreinforced resin composition of claim 7, wherein said complementary, non-reactive material is one or more of nylon, polystyrene, or polypropylene.

10. The curable unreinforced resin composition of claim 1, which further comprises one or more of catalysts, flame-retardants, organic solvents, and curing agents.

11. The curable unreinforced resin composition of claim 1, wherein said poly(arylene ether) polyvinyl resin has an average molecular weight of between about 900 and 10,000.

12. The curable unreinforced resin composition of claim 1, wherein said poly(arylene ether) comprises poly(phenylene ether) compounds of general structure, 1:
Q-(J-K)_{y} 1
wherein Q is the residuum of a phenol and comprises radicals of the following structure, 2: 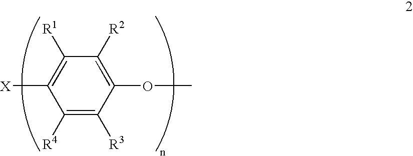
wherein, for structure 2, X is hydrogen, substituted or unsubstituted C₁₋₁₀₀ alkyl, aryl, and mixed alkyl-aryl hydrocarbons, or such hydrocarbon groups containing a substituent selected from the group consisting of carboxylic acid, halogen, aldehyde, alcohol, and amino radicals; X may be sulfur, sulfonyl, sulfuryl, oxygen, or other such bridging group having a valency of 2 to result in bis- or higher polyphenols; R¹⁻⁴ independently may be hydrogen, substituted or unsubstituted C₁₋₁₀₀ alkyl, alkenyl, alkynoyl, aryl, mixed alkyl-aryl hydrocarbons, or such groups also containing a substituent selected from the group consisting of carboxylic acid, aldehyde, alcohol, halogen, and amino functionality; y and n independently range from about 1-100; and J comprises recurring units of the following structure, 3: 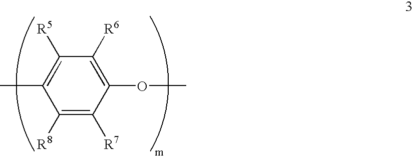
wherein, for structure 3, R⁵⁻⁸ independently may be hydrogen, alkyl, alkenyl, alkynoyl, aryl, mixed alkyl-aryl hydrocarbons, or such groups also containing a substituent selected from the group consisting of carboxylic acid, aldehyde, alcohol, and amino functionality, and m ranges from 1-200; and K has the following structure: 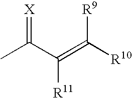
wherein X is O, S, or two hydrogens, and wherein R⁹⁻¹¹ are independently a hydrogen or substituted or unsubstituted C₁₋₁₀₀ alkyl or aryl or mixed alkyl or aryl group,
wherein any of the foregoing “R” substituents optionally may be partially or fully halogenated, and wherein, any one of the R⁵⁻⁸ substituents also may be used for the R¹⁻⁴ groups.

13. The curable unreinforced resin composition of claim 12, wherein said poly(phenylene ether (PPE) comprises those of the general structure, 1:
Q-(J-K)ₘ 1
wherein Q is the residuum of a phenol;
J comprises recurring units of the following structure, 3: 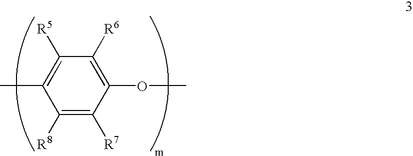
wherein, for structure 3, R⁵⁻⁸ independently is selected from hydrogen, alkyl, alkenyl, alkynoyl, aryl, mixed alkyl-aryl hydrocarbons, wherein such groups may contain a substituent selected from carboxylic acid, aldehyde, alcohol, and amino functionality; K has the following structure: 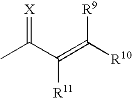
wherein R⁹⁻¹¹ is a hydrogen or substituted or unsubstituted C₁₋₁₀₀ alkyl or aryl or mixed alkyl or aryl group; X is an oxygen, and m ranges from 1-200.

14. A curable unreinforced resin composition comprising:
(a) at least one poly(arylene ether) polyvinyl resin having a molecular weight between about 900 and 2,900 obtained through a redistribution reaction; and
(b) at least one vinyl or acrylic-substituted resin.

15. The curable unreinforced resin composition of claim 13, wherein said poly(arylene ether) polyvinyl resin has an average molecular weight of between about 1,200 and 7,500.

16. The curable unreinforced resin composition of claim 13, wherein said poly(arylene ether) polyvinyl resin has an average molecular weight of between about 3000 and 10,000.

17. The curable unreinforced resin composition of claim 16, which additionally comprises a complementary, non-reactive material being one or more of a thermoset resin, a thermoplastic resin, or an elastomeric resin.

18. The curable unreinforced resin composition of claim 16, wherein said poly(arylene ether) polyvinyl resin has a number average molecular weight between about 3100 to about 5500.

19. The curable unreinforced resin composition of claim 16, which further comprises one or more of catalysts, flame-retardants, organic solvents, and curing agents.

20. The curable unreinforced resin composition of claim 19, which additionally comprises a catalyst.

21. A B-stage thermoset molding composition, comprising the partially cured residue of the curable resin composition of claim 1.

22. A B-stage thermoset molding composition, comprising the partially cured residue of the curable resin composition of claim 4.

23. A B-stage thermoset molding composition, comprising the partially cured residue of the curable resin composition of claim 14.

24. A B-stage thermoset molding composition, comprising the partially cured residue of the curable resin composition of claim 16.

25. An article of manufacture, which comprises an article molded from the B-stage thermoset composition of claim 21.

26. An article of manufacture, which comprises an article molded from the thermoset composition of claim 1.

27. An article of manufacture, which comprises an article molded from the B-stage thermoset composition of claim 22.

28. An article of manufacture, which comprises an article molded from the thermoset composition of claim 4.

29. An article of manufacture, which comprises an article molded from the B-stage thermoset composition of claim 23.

30. An article of manufacture, which comprises an article molded from the thermoset composition of claim 14.

31. An article of manufacture, which comprises an article molded from the B-stage thermoset composition of claim 24.

32. An article of manufacture, which comprises an article molded from the thermoset composition of claim 16.

33. A substrate coated with an adhesive layer of the curable composition of claim 1.

34. The substrate of claim 33, wherein the adhesive layer is at least partially cured.

35. The substrate of claim 34, having a second substrate bonded thereto by said at least partially cured adhesive composition to form a laminate.

36. The substrate of claim 33, which is an electrically conductive metal.

37. The substrate of claim 36, wherein said conductive metal is copper.

38. The substrate of claim 36, which is flexible.

39. A first substrate coated with an adhesive layer of the curable composition of claim 14.

40. The first substrate of claim 39, wherein
(a) said first substrate is a thermoplastic film, which is not said resin of claim 14;
(b) said adhesive layer is coated on one or both sides of said first substrate; and
(c) a layer of copper is optionally laminated to said thermoplastic film by said adhesive layer.

41. A laminated article, comprising a second substrate adhesively bound with said adhesive layer to the adhesively coated first substrate of claim 39.

42. A flexible article, comprising two flexible substrates laminated together with said curable composition of claim 1.

43. A laminate, comprising three or more substrates having the at least partially cured adhesive curable composition of claim 34 disposed between each adjacent substrate.

44. The laminate of claim 43, wherein said curable composition is fully cured.

45. The laminate of claim 43, wherein said substrates are formed from a conductive metal.

46. The laminate of claim 44, wherein said substrates are copper.

47. The laminate of claim 44 formed from flexible substrates, wherein said curable composition is cured and the laminate is flexible.

48. The laminate of claim 47, wherein said curable composition was cured by one or more of heat, ultraviolet light, or electron beam.

49. A flexible laminate, comprising two or more flexible substrates, wherein said laminates are bonded together with the curable composition of claim 14.

50. A cured film of the curable unreinforced resin composition of claim 48.

51. The cured film of claim 50, which is bonded to a substrate.

52. The cured film of claim 50, which has a metalized film deposited thereon, said metal being one or more of zirconium, zirconium nitride, titanium, titanium nitride, zirconium carbonitride, chromium, chromium nitride, nickel, nickel nitride, titanium carbonitride, gold, silver, carbon nitride, aluminum, or molybdenum.

53. The cured film of claim 52, wherein the metal comprises copper.

54. The cured film of claim 53, wherein said copper was deposited on only one side of said cured film.

55. The cured film of claim 53, wherein said copper was deposited on both side of said cured film.

56. A film of the curable unreinforced resin composition of claim 6, which has had a metalized film deposited thereon.

57. A laminate, comprising adhesively coated substrate of claim 32 bound to the cured film of claim 53.

58. The cured residue of the curable unreinforced resin composition of claim 20.

59. The cured residue of claim 58, which was cured by one or more of by heat, ultraviolet light, or electron beam.

60. The cured residue of claim 59, which had a metal layer applied to at least one side thereof prior to said curing.

61. The cured residue of claim 60, wherein said metal layer was applied by vapor deposition of a metal being one or more of zirconium, zirconium nitride, titanium, titanium nitride, zirconium carbonitride, chromium, chromium nitride, nickel, nickel nitride, titanium carbonitride, gold, silver, carbon nitride, aluminum, or molybdenum.

62. The cured residue of claim 60, wherein said metal comprises copper.

63. The cured residue of claim 62, wherein said copper is present is on only one side.

64. The cured residue of claim 62, wherein said copper is present is on both sides.

65. An article comprising, a film of the cured residue of claim 61 having a layer of the composition of claim 1 applied on said film.

66. An article comprises, a film of the cured residue of claim 61 having a layer of the composition of claim 1 applied on both sides of said film.

67. An article comprising, a film of the cured residue of claim 62 having layer of the composition of claim 1 applied thereon.

68. An article comprising, the adhesively coated substrate of claim 34 bound to the cured residue of claim 60.

69. An article comprising, a dissimilar thermoplastic film having a layer of copper on one side, both sides, or no side, said dissimilar thermoplastic film being bound to the adhesively coated substrate of claim 34.

70. The catalyzed film of claim 50, which additionally comprises an anti-solvent component in the curable unreinforced resin composition.

71. The catalyzed film of claim 50 adhered to a release agent film.

72. The catalyzed film of claim 58, which additionally comprises an anti-solvent component in the curable unreinforced resin composition.

73. The catalyzed film of claim 58 adhered to a release agent film.
